(19) United States
(12) Patent Application Publication
(10) Pub. No.: US 2026/0356573 A1
(43) Pub. Date: Nov. 12, 2026

(54) An Aerosol Container

(71) Applicant: Samurai 2K Aerosol SDN. BHD., Skudai, Johor (MY)

(72) Inventor: Yoke En ONG, Skudai, Johor (MY)

(21) Appl. No.: 19/488,024

(22) PCT Filed: Aug. 16, 2023
(86) PCT No.: PCT/MY2023/050064

§ 371 Date: Nov. 25, 2025

(30) Foreign Application Priority Data
May 25, 2023 (MY) PI2023003130

(51) Int. Cl. B65D 83/666; B65D 83/16; B65D 83/36; B65D 83/48

(52) U.S. Cl. CPC B65D 83/666; B65D 83/162; B65D 83/36; B65D 83/48

(57) ABSTRACT

The present invention belongs to the technical field of aerosol technology and relates to a kind of aerosol container. The aerosol container comprises a can body (100), a receptacle (300) located within the can body (100) for hermetically storing content, and a protection assembly (200) located within the can body (100) and external to the receptacle (300) for isolating the receptacle (300) from a space external to the protection assembly (200) prior to using the aerosol container. The described aerosol container provides improved operational reliability.

### FIELD OF INVENTION

The present invention belongs to the technical field of aerosol technology and relates to a kind of aerosol container.

### BACKGROUND OF THE INVENTION

It is known that polyester paint, which has seen wide use, cannot be used with conventional aerosol containers. This is because that polyester paint needs to be mixed with a modifier for it to be used. However, even though it has been mixed with a modifier, the mixture will solidify after a few hours, and as a result, it cannot be sprayed out from the aerosol container. Therefore, it is preferable that the modifier is mixed with the propellant and the coating (e.g., polyester paint) only when it is required. As such, it is necessary for the modifier to be stored hermetically within a receptacle as its content, within the aerosol container, which is only broken when required.

The receptacle may be made from a material that is the same as the aerosol container (i.e., aluminium) for storing the coating. However, considerations should also be made should it be required for the receptacle to store modifiers that are highly corrosive in nature (e.g., hydrochloric acid) as the receptacle will have a risk of being corroded. As such, it is preferable that the receptacle is made from corrosion-resistant material such as glass instead of aluminium.

However, a mixing member, such as a mixing ball, is also usually provided within the aerosol container. The mixing member may impact the receptacle having the modifier during transport or storage of the aerosol container, and the breakable nature of glass may further aggravate this. This may result in a premature leakage of the modifier, which shall eventually render the aerosol container unusable.

### SUMMARY OF INVENTION

In order to improve the operational reliability of aerosol containers when in use, the present invention proposes an aerosol container.

The present invention intends to provide an aerosol container comprising a can body, a receptacle, and a protection assembly. The receptacle is located within the can body for hermetically storing content, and the protection assembly is located within the can body and external to the receptacle for isolating the receptacle from a space external to the protection assembly prior to use of the aerosol container.

Advantageously, by hermetically storing content within the receptacle and having the protection assembly to protect the receptacle, it is possible to prevent the receptacle from being impacted by the mixing balls during transport or storage of the aerosol container, which could have caused damage to the receptacle and premature leakage of the content. Moreover, it is possible to prevent the pressure force exerted by the propellant from damaging the receptacle. As such, the operational reliability of the receptacle in storing content is increased, thereby increasing the operational reliability of the aerosol container.

Preferably, the protection assembly comprises a protective casing, and a piston shaft in connection with the protective case that is configured to apply pressure to the receptacle for breaking it so that its content is released therefrom.

Preferably, the protective casing comprises an inner case and an outer case, with the outer case covering at least an outer lower portion of the inner case, and the inner case covering at least an outer lower portion of the receptacle.

Preferably, the inner case comprises a first connective channel at its lower portion, and the outer case comprises a second connective channel at its lower portion.

Preferably, the inner case and the outer case are arranged to move relative to each other, with the inner case movable from a first position to a second position.

Preferably, the first connective channel and the second connective channel are blocked off from each other when the inner case is at the first position, and the first connective channel and the second connective channel are connected to each other when the inner case is at the second position.

Preferably, the first connective channel and the second connective channel, when the inner case is at the first position, are blocked off at locations being between the first connective channel and the second connective channel, and between the first connective channel and the top portion of the outer case.

Preferably, the inner case is connected to the outer case through a first sealing ring in a hermetic manner, or the inner case is connected to the outer case through an interference fit between them in a hermetic manner.

Preferably, wherein the piston shaft comprises a pressure-application section that applies pressure to the receptacle.

Preferably, the receptacle has its receptacle tip abutting base walls of the inner case, and the receptacle has an outer portion of its base being abutted by the pressure-application section of the piston shaft which applies pressure thereto.

Preferably, the piston shaft is connected to the protective casing through a second sealing ring in a hermetic manner, or the piston shaft is connected to the protective casing through an interference fit between them in a hermetic manner.

Preferably, the piston shaft has a flange portion, with a peripheral surface of the flange portion being connected to the protective casing through the second sealing ring in a hermetic manner, or connected to the protective casing through an interference fit between them in a hermetic manner.

Preferably, the receptacle has its base abutted by a projection of the inner case that formed on an inner surface portion of base walls of the inner case, and the receptacle has its shoulders abutted by a bottom portion of the piston shaft.

Preferably, the projection of the protective casing and lower edges of the inner case have an annular area therebetween, for abutting lower edges of the receptacle after the receptacle base is broken.

Preferably, the piston shaft is connected to the protective casing through a third sealing ring in a hermetic manner, or the piston shaft is connected to the protective casing through an interference fit between them in a hermetic manner.

Preferably, the piston shaft is connected to the inner case through the third sealing ring in a hermetic manner, or the piston shaft is connected to the inner case through an interference fit between them in a hermetic manner.

Preferably, the aerosol container further comprises a control valve, which comprises a valve housing disposed within the can body in a hermetic manner, a valve stem, which is disposed within the valve housing, and a resilient member, for pushing the valve stem so that valve stem and valve housing remain connected in a hermetic manner.

Preferably, the valve stem has its tip passed through an upper portion of the valve housing along the axial direction; and the valve stem has its bottom end passed through a lower portion of the valve housing along the axial direction, such that when the valve stem moves towards the protective casing, the valve stem pushes the piston shaft for the piston shaft to break the receptacle so that the content is released therefrom.

Preferably, the aerosol container further comprises additional control valves.

Preferably, the receptacle is breakable and corrosion-resistant.

Preferably, the aerosol container further comprises mixing members disposed between the protection assembly and the can body.

Preferably, the valve housing has its side walls providing a third connective channel, which is used to connect a first space being space between the valve stem and the valve housing, and connect a second space being space between the valve housing and the inner surface of the can body. The piston shaft has its inner side surface connected to the valve housing in a hermetic manner, and its top portion is used to block or unblock the third connective channel.

Preferably, the valve stem has its lower portion connected to a through-hole at the base of the valve housing in a hermetic manner, and has its middle portion provided with a guide channel. When the lower portion of the valve stem protrudes out from the valve housing at a maximum value, the guide channel establishes a connectivity between a first space and a second space. The first space is defined as a space between the valve housing and the valve stem, while the second space is defined as a space between valve housing and the internals of the can body. When the valve stem is not depressed, the entirety of the guide channel is to be within the valve housing.

Preferably, the guide channel further comprises a flow-guiding groove that is parallel to the radial direction of the valve stem or along the radial direction of the valve stem. The flow-guiding groove is at least recessed at the peripheral surface of the lower portion of the valve stem and extends along the axial direction of the valve stem. When the lower portion of the valve stem protrudes out from the valve housing at a maximum value, portions of the flow-guiding groove are located within the valve housing, and its remaining portions are located outside of the valve housing.

Preferably, the valve stem further comprises a discharge channel at its top portion, with the discharge channel encompassing an outlet located on the tip of the valve stem, and an inlet located on the upper surface portion of the valve stem.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

FIG. 1 is a schematic illustration of the aerosol container of the present invention in its first embodiment.

FIG. 2 is a schematic illustration of the aerosol container of the present invention in its second embodiment.

FIG. 3 is a schematic illustration of the aerosol container of the present invention in its third embodiment in a configuration whereby its valve stem is yet to be depressed.

FIG. 4 is a schematic illustration of the aerosol container of the present invention in its third embodiment in a configuration whereby its piston shaft had pushed its inner case to assume a certain position.

FIG. 5 is a schematic illustration of the control valve of the aerosol container as per FIG. 1.

FIG. 6 is a schematic illustration of the aerosol container in a fourth embodiment whereby the upper portion of the piston shaft and the lower portion of the valve stem are in a threaded engagement with each other.

FIG. 7 is a schematic illustration of the aerosol container of the fourth alternative embodiment whereby its control valve is to receive a corresponding nozzle.

FIG. 8 is an illustration of an external perspective view of the aerosol container of the fourth embodiment, specifically showing its corresponding nozzle.

FIG. 9 is a schematic illustration of the aerosol container in a fifth embodiment having more than one valve stems, with a first valve stem being configured according to the third embodiment as shown in FIG. 3, and a second valve stem that is configured to dispense content from the aerosol container.

FIG. 10 is an illustration of an external perspective view of the aerosol container of the fifth embodiment, with its corresponding nozzles.

FIG. 11 is a schematic illustration of the aerosol container in a sixth embodiment having more than one valve stem, with a first valve stem being configured according to the fourth embodiment as shown in FIG. 6, and a second valve stem that is configured to dispense content from the aerosol container.

FIG. 12 is an illustration of an external perspective view of the aerosol container of the sixth embodiment, with its corresponding nozzles.

### DETAILED DESCRIPTION OF THE INVENTION

For facilitating an understanding of the purpose, structure, and functionality of the present invention, the present invention is described in further detail below with reference to the accompanying drawings.

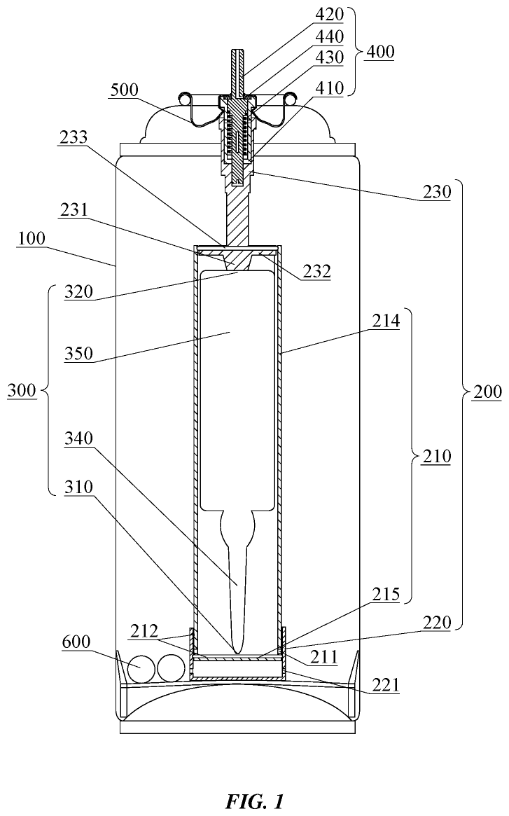

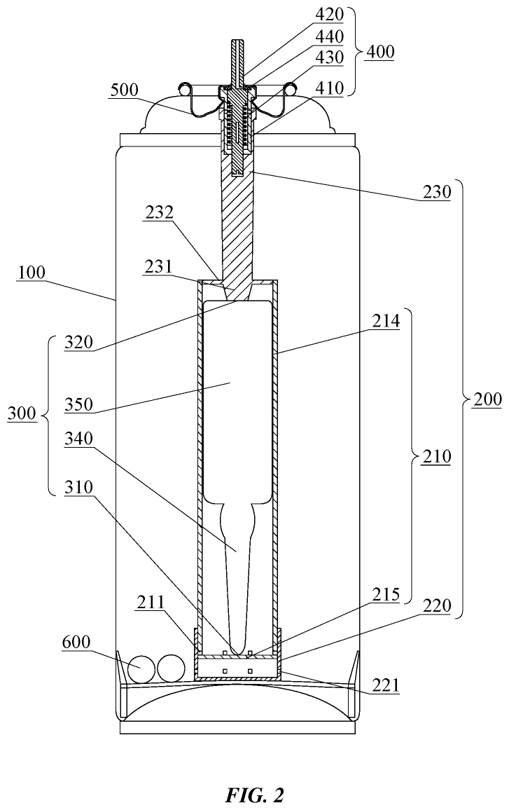

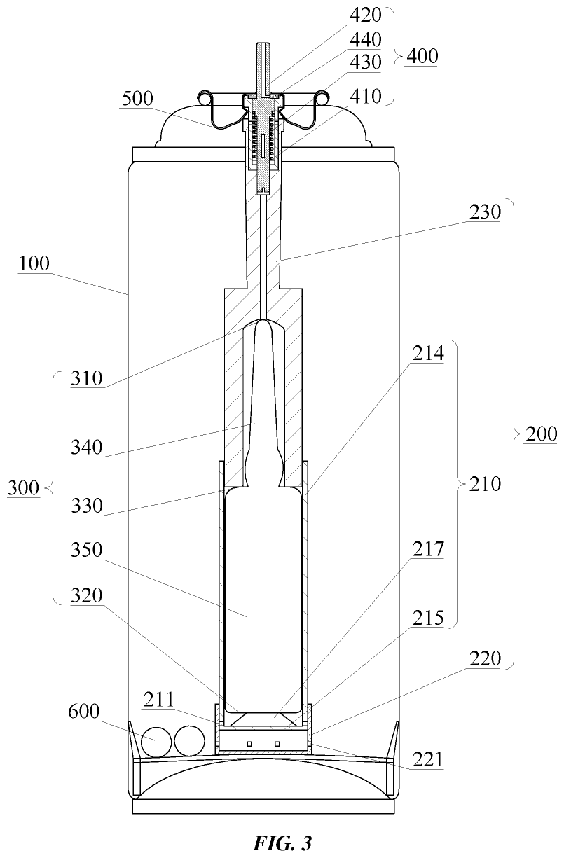

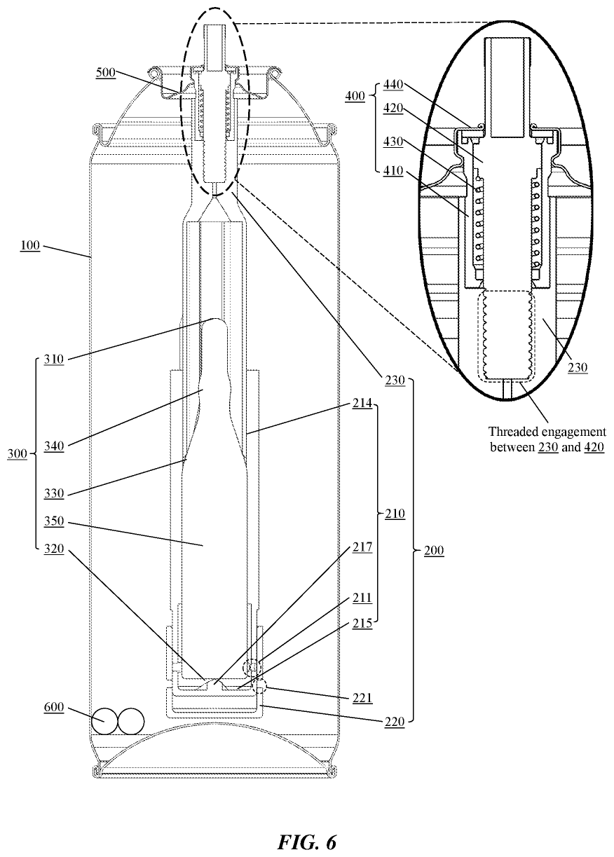

FIG. 1 is a schematic illustration of the aerosol container of the present invention in its first embodiment. FIG. 2 is a schematic illustration of the aerosol container of the present invention in its second embodiment. FIG. 3 is a schematic illustration of the aerosol container of the present invention in its third embodiment in a configuration whereby its valve stem is yet to be depressed. FIG. 6 is a schematic illustration of the aerosol container of the present invention in its fourth embodiment. As shown in FIGS. 1, 2, 3 and 6, each of these embodiments provides an aerosol container comprising a can body 100, a receptacle 300 located within the can body 100 for hermetically storing content, and a protection assembly 200 located within the can body 100 but external to the receptacle 300 for isolating the receptacle 300 from a space external to the protection assembly 200 prior to use of the aerosol container.

It is to be noted that it is preferable that fluids (i.e. liquids or gases) are within the aerosol container. In particular, the aerosol container may be used in such a way that propellant is stored in the space between the protection assembly 200 and the can body 100, which may be high-pressure gas. Whereas, content (e.g., a paint base) is stored in the receptacle 300. It is noted that the aerosol container may also be used in such a way that propellant and a paint base are stored in the space between the protection assembly 200 and the can body 100, while modifiers (e.g., toluene diisocyanate, hydrochloric acid, etc.) is stored in the receptacle 300 as content.

When the aerosol container is to be used, the content from the receptacle 300 and the propellant are to be mixed first, for the mixed content to be then sprayed out from the aerosol container under the entrainment of the propellant. In order to improve the mixing between the content and the propellant, one or more mixing members 600, such as mixing balls, is typically disposed in the space between the protection assembly 200 and the can body 100.

By having the content stored within the receptacle 300 in a hermetic manner, and by having the protection assembly 200 protect the receptacle 300, it is possible to prevent the receptacle 300 from being impacted by the mixing members 600 during transport or storage of the aerosol container, which could have caused damage to the receptacle 300 and premature leakage of the modifier. Moreover, it is possible to prevent the pressure force exerted by the propellant from damaging the receptacle 300. As such, the operational reliability of the receptacle 300 in storing content is increased, thereby increasing the operational reliability of the aerosol container.

As shown in FIGS. 1, 2, 3 and 6, preferably, the protection assembly 200 further comprises a protective casing, a piston shaft 230 that moves relative to the protective casing while being hermetically connected to it, with the piston shaft 230 used to apply a pressure force to the receptacle 300, having content therein, for breaking it from its sealed state.

The piston shaft 230 is to be driven by an external force (e.g., pressure from a control valve) for it to exert a force onto the receptacle 300. When the receptacle 300 experiences an external force exerted by the piston shaft 230 that is large enough, it shall break and its stored content will be released. With the piston shaft 230 and the protective casing being slidably movable relative to each other and while being hermetically connected together, the receptacle 300 may be shielded from the pressure force exerted by the high-pressure propellant within the can body 100, thereby preventing the receptacle 300 from being broken by this pressure force. With this, the operational reliability of the receptacle 300 in storing content is increased.

As shown in FIGS. 1, 2, 3 and 6, preferably, the protective casing further comprises an inner case 210 and an outer case 220, with the outer case 220 at least covering an outer-lower portion of the inner case 210, and with the inner case 210 at least covering an outer-lower portion of the receptacle 300.

In particular, the outer case 220 is disposed externally to the inner case 210, and the inner case 210 is disposed externally to the receptacle 300. In a first, second and third embodiments which shall be described below, the outer case 220 covers the lower portion of the inner case side walls 214 and the inner case base walls 215. Alternatively, the outer case 220 may cover the entirety of the inner case side walls 214 and the inner case base walls 215. In the first embodiment and the second embodiment which shall be described below, the inner case 210 covers the entire side surfaces of the receptacle 300 and its illustrated base. In the third embodiment which shall be described below, the inner case 210 only covers the lower-half side surfaces of the receptacle 300 and its illustrated base.

With the outer case 210 and the inner case 220 providing a double-layer protection, the protection of the receptacle 300 will be strengthened. Not only that, a relative movement between the outer case 210 and the inner case 220 for changing a connectivity between the protective casing and its external environment is realised. This will allow control over the content within the receptacle 300 for it to be released and entrained with the propellant, for it to eventually be sprayed out from the aerosol container.

As shown in FIGS. 1, 2, 3 and 6, preferably, the lower portion of the inner case 210 has a first connective channel 211 and the lower portion of the outer case 220 has a second connective channel 221. With the inner case 210 and the outer case 220 configured to move relative to each other, the inner case 210 may move from a first position to a second position. When the inner case 210 is at the first position, the first connective channel 211 and the second connective channel 221 are blocked off from each other. Whereas, when the inner case 210 is at the second position, a clear path is formed between the first connective channel 211 and the second connective channel 221.

In particular, the path of the first connective channel 211 includes a through-hole at the inner case side walls 214, located at the base of the inner case side walls 214. Whereas, the path of the second connective channel 221 includes a through-hole at the side walls of the outer case 220, located at the base of the side walls of the outer case 220. When the inner case 210 is at the second position, preferably, the opening of the first connective channel 211, or partial areas of it, overlaps with the second connective channel 221. But most preferably, the opening of the first connective channel 211 is aligned to the second connective channel 221. With this, content within the inner case 210 is able to continuously flow through the first connective channel 211 and the second connective channel 221.

In addition, regarding the first connective channel 211 and the second connective channel 221, their angular positions relative to the circumference of the protective casing along its axial axis are not perfectly coincident. That is, such a condition shall not occur. When the inner case 210 and the outer case 220 are at a certain relative angle, a clear path is correspondingly formed between the first connective channel 211 and the second connective channel 221. Also, when the first connective channel 211 and the second connective channel 221 are rotated to be at another relative angle, the first connective channel 211 and the second connective channel 221 may be blocked off from each other. Hence, as long as both of them remain at a consistent height, a partially clear path should be formed between the first connective channel 211 and the second connective channel 221. With this, a connectivity between a space internal to the inner case 210 and a space external to the outer case 220 is realised.

With the first connective channel 211 and the second connective channel 221 configured as such, a control over the position of the inner case 211 may allow for a control over the connectivity between the first connective channel 211 and the second connective channel 221. Hence, a method for controlling the position of the inner case 210 can be employed to control the connectivity between a space internal to the inner case 210 and a space external to the outer case 220. Furthermore, it is possible for a component that actuates a positional change of the inner case 210 and a component that breaks the receptacle 300 for releasing its contents to be one and the same, and under a unidirectional pressing operation, said component will independently perform both actions. With this, a coherency in actions is realised, thereby increasing the operational effectiveness of the aerosol container.

As shown in FIGS. 1 and 2, preferably, when the inner case 210 is at the first position, a hermetic location of the inner case 210 and the outer case 220 is located between the first connective channel 211 and the second connective channel 221, and between the ends of the first connective channel 211 and the second connective channel 221. A first sealing ring 212 provides a hermetic connection between the inner case 211 and the outer case 221. Alternatively, an interference fit between the inner case 211 and the outer case 220 provides a hermetic connection between them.

In particular, it is possible for the circumferential surface of the inner case base walls 215 (more specifically, the circumferential surface of the lowermost portion of the inner case side walls 214) and the inner walls of the outer case 220 to have a hermetic connection between each other. More precisely, the first sealing ring 212 is at a location on the inner case side walls 214 that is relatively lower than the first connective channel 211. Alternatively, an interference fit between the said location and the outer case 220 provides a hermetic connection between them. With this, when the inner case 210 is at the first position, the realised hermetic location is located between the first connective channel 211 and the second connective channel 221, thereby making them blocked off from each other. Whereas, when the inner case 210 is at the second position, the first connective channel 211 and the second connective channel 221 are positionally aligned to one another, as the hermetic location is now located at a location relatively lower than the first connective channel 211. As such, there is no obstruction between the first connective channel 211 and the second connective channel 221, thereby forming a clear path for the flow of content from the inner case 210 to the outer case 220.

In addition, it is also possible for a hermetic location between the first connective channel 211 and the top end of the outer case 220 to be at a location on the peripheral surface of the inner case 210 that is relatively higher than the first connective channel 211. This shall also effectively provide a sealing effect when the inner case 210 is at the first position, in which a path for the first connective channel 211 to reach the space external to the outer case 220 through the upper side walls of the outer case 220 is blocked off.

With the use of the first sealing ring 212 or the interference fit between the first connective channel 211 and the second connective channel 221, more specifically, between the ends of the first connective channel 211 and the second connective channel 221, when the inner case 210 is at the first position, it is possible for the first connective channel 211 and the second connective channel 221 to be blocked off from each other, thereby blocking off a path for the first connective channel 211 to reach the space external to the outer case 220. With this, it is possible to prevent the receptacle 300 from being subjected to excess pressure force exerted by the propellant that is external to the outer case 220, which could have affected the stability of the receptacle 300. Whereas, when the inner case 210 is at the second position, the hermetic location, in which the seal or interference fit is located, will not affect the flow of content from the receptacle 300 to the space external to the outer case 220.

As shown in FIGS. 1 and 2, preferably, the piston shaft 230 further comprises a pressure-application section 231, which exerts a pressure force onto the receptacle 300.

In particular, as shown in the first embodiment and the second embodiment which are to be described below, the piston shaft 230 may have a body that is a column shape or a frustum shape, with the pressure-application section 231 situated at its bottommost portion. The body of the piston shaft 230 has a diameter that is smaller than the diameter of the receptacle 300, so that it can fully act upon the receptacle base 320. More specifically, the force applied by the body of the piston shaft 230 is concentrated onto the centre of the receptacle base 320. Hence, when the piston shaft 230 applies a considerable amount of pressure force onto the receptacle base 320, it may break the receptacle base 320.

With the pressure-application section 231 of the piston shaft 230 applying a pressure force onto the receptacle 300, the relative position between the inner case 210 and outer case 220 is changed, thereby changing a connectivity between the first connective channel 211 and the second connective channel 221 from them being blocked off to allowing a connection between the two. After the inner case 210 is pushed for it to move relative to the outer case 220 up to a certain position, there will be no relative change in position between the inner case 210 and the outer case 220. Further application of pressure force will then cause the receptacle 300 to break for its content stored there within to be released and entrained with the propellant to be sprayed out. With this, it is demonstrated that a movement of the piston shaft 230 towards a direction will cause both of the following to be done, namely, a change in connectivity between the space internally within the inner case 210 and the space external to the outer case 220, and breaking of the receptacle 300. Both of these may be done in one go by the piston shaft 230, thereby providing increased efficiency of action as well as operational improvements.

As shown in FIGS. 1 and 2, the receptacle 300 has characteristics such that its body is breakable, and may further be corrosion-resistant. The receptacle tip 310 abuts the inner case base walls 215, and the pressure-application section 231 is configured to apply a pressure force onto the outer portion of the receptacle base 320. It is also much preferred that the body of receptacle 300 is rigid, however, embodiments of the receptacle 300 may further extend to it having a pliable body that includes the aforementioned characteristics, with its pliable body breaking by being ruptured or punctured when receiving an external force that overcomes its structural integrity. Hence, the material composition of the receptacle 300 may be selected from a group of materials, which may be, but shall not be limited to glass, ceramics, corrosion-resistant plastics, plastics, or the like.

In particular, the receptacle 300 may have an appearance similar to that of an ampoule which is commonly used medically for the administration of injections. In particular, as well, the receptacle 300 has an upper portion 340 and a lower portion 350. The receptacle's upper portion 340 may have a tapered structure, or it may have a dilated neck portion at the base of this tapered structure. Between the dilated neck portion and the receptacle's lower portion 350 is a reduced-diameter section. Should breaking of the receptacle 300 be required, a force is to be applied along the radial axis of the aforementioned tapered structure. Should the receptacle's upper portion 340 have a substantially tapered structure, when hit, the receptacle's upper portion 340 and the receptacle's lower portion 350 may separate from each other due to a break occurring at the base of the tapered structure. Should the receptacle's upper portion 340 have a dilated neck portion, when hit, the receptacle's upper portion 340 and the receptacle's lower portion 350 may separate from each other due to a break occurring at the reduced-diameter section.

It should be noted that the receptacle 300 only has an appearance similar to an ampoule, and it does not necessarily have dimensions similar to a conventional ampoule or a shape that bears similarity to an ampoule. Should the need to store content at a volume that exceeds the volume of a conventional ampoule arises, it is possible to use a receptacle that has an appearance similar to a conventional ampoule, but having enlarged dimensions.

In addition, the concepts relating to the receptacle base 320, the receptacle tip 310, the receptacle shoulders 330, the receptacle's upper portion 340, and the receptacle's lower portion 350, as put forward within this application, shall not be limited by the orientational arrangement of the receptacle 300. More specifically, the arrangement orientation of the receptacle 300 is not to be limited to how it is conventionally done, and it may be in an upright manner or an inverted manner for the content stored therewithin and at the receptacle's lower portion 350 to be at the upper half or the lower half of the receptacle 300. The receptacle base 320 refers to a position along the receptacle's lower portion 350 that is furthest from the receptacle's upper portion 340. The receptacle tip 310 refers to a tapered end along the receptacle's upper portion 340. The receptacle shoulders 330 refers to a joining between the receptacle's upper portion 340 and the receptacle's lower portion 350, whereby the receptacle's upper portion 340 has a dilating diameter compared to the receptacle's lower portion 350, or the receptacle's lower portion 350 has a tapering diameter compared to the receptacle's upper portion 340. Accordingly, the receptacle's lower portion 350 refers to a main cylindrical body of the ampoule bottle that usually stores liquid content, while the receptacle's upper portion 340 refers to portions of the ampoule having the tapered structure, which may include its dilated-diameter section.

The pressure-application section 231 is configured to apply a pressure force onto the outside of the receptacle base 320, more precisely, the base of the ampoule, with the ampoule being arranged in an inverted manner. The receptacle tip 310, more precisely the tip of the ampoule, is to face the bottom end of the inner case 210. When the ampoule receives an applied, which may be more specifically a downward pressure force, its upper portion 340 may break. As such, content within the receptacle 300 is released into the lower half of the inner case 210, which is closer to the first connective channel 211 located at the lower end of the inner case side walls 214. With this, the content may quickly flow to the space external to the outer case 220, thereby allowing spraying to be done instantaneously.

As shown in FIGS. 1 and 2, preferably, the inner case 210 further comprises an inner case body.

In particular, the inner case body includes the inner case side walls 214 and the inner case base walls 215. The inner case side walls 214 and the inner case base walls 215 are to be integrally formed as a single piece. With the exception of the first connective channel 211, the inner case side walls 214 and the inner case base walls 215 are substantially joined. More specifically, only the first connective channel 211 provides a connectivity between the outside and the inside of the inner case 210.

As shown in FIGS. 1 and 2, preferably, a second sealing ring provides a hermetic connection between the piston shaft 230 and the protective casing. Alternatively, an interference fit between the piston shaft 230 and the protective casing provides a hermetic connection between them.

By using a second sealing ring or an interference fit to provide a hermetic connection between the piston shaft 230 and the protective casing, the high-pressure propellant external to the protective casing is prevented from entering the protective casing through spaces between the piston shaft 230 and the protecting casing. With this, the receptacle 300 is prevented from being subjected to pressure exerted by the propellant, which could have broken the receptacle 300.

Preferably, the piston shaft 230 further comprises a flange portion 232. A second sealing ring may provide a hermetic connection between the circumferential surface of this flange portion 232 and the protective casing. Alternatively, an interference fit between the circumferential surface of this flange portion 232 and the protective casing may provide a hermetic connection between them.

In particular, in the first, second and third embodiments to be described below, there is a hermetic connection between the circumferential surface of the flange portion 232 and the inner sidewalls of the inner case 210. Amongst them, as shown in FIG. 1, in the first embodiment, a second sealing ring is provided on the circumferential surface of the flange portion 232 for a hermetic connection between it and the inner sidewalls of the inner case 210. Whereas, as shown in FIG. 2, in the second embodiment, an interference fit between the flange portion 232 and the inner sidewalls of the inner case 210 provides a hermetic connection between them. In the case of a hermetic connection through interference fits, it should be noted that a person should be able to exert a force to cumulatively overcomes the aforementioned interference fit, as well as the interference fit between the inner case 210 and the inner walls of the inner case 210, and the structural integrity of receptacle 300 for it to break. Else, a force of one or a few hundred kilograms would be required to overcome both interference fits, the operation of the aerosol container will be extremely difficult, and in turn, its efficiency is significantly reduced.

Through a hermetic connection between the circumferential surface of the flange portion 232 and the inner case 210, the inner case 210 is protected from the high-pressure propellant external to it, which could have entered it from the outside through the piston shaft 230. As such, an isolation of the internals of inner case 210 from the space external to it is achieved, which shall allow the receptacle 300 within the protective casing to be in a region of lower pressure, thereby preventing the receptacle 300 from being broken by the high-pressure propellant.

In an alternative implementation, the top end of the outer case 220 may also be at a position higher than the top end of the inner case 210, with a hermetic connection between the circumferential surface of the flange portion 232 and the inner case 210. Such an alternative implementation may also prevent the internals of the inner case 210 from having a connectivity with the space external to the inner case 210 through the top of the outer case 220.

As shown in FIGS. 3 and 6, the receptacle 300 has characteristics such that its body is breakable, and may further be corrosion-resistant, with the base walls of the inner case 220 configured to have a projection 217. The projection 217 abuts the receptacle base 320, and the base of the piston shaft 230 abuts the receptacle shoulders 330. It is also much preferred that the body of receptacle 300 is rigid, however, embodiments of the receptacle 300 may further extend to it having a pliable body that includes the aforementioned characteristics, with its pliable body breaking by being ruptured or punctured when receiving an external force that overcomes its structural integrity. Hence, the material composition of the receptacle 300 may be selected from a group of materials, which may be, but shall not be limited to glass, ceramics, corrosion-resistant plastics, plastics, or the like.

In particular, the projection 217 is configured to be at the centre of the inner case base walls 215, having a frustoconical or conical shape that projects inwardly towards the internals of the inner case 210. After the receptacle 300 receives an applied force, preferably one that is in the downward direction, the projection 217 may break the receptacle base 320 of the receptacle 300, causing content stored therein, to be released therefrom. The bottom portion of the piston shaft 230 may be provided with an accommodation space that accommodates the receptacle's upper portion 340.

With the base of the piston shaft 230 being configured to abut the receptacle shoulders 330, it is possible for the force exerted by the piston shaft 230 to be borne by the receptacle shoulders 330, which may also be borne by the side walls of the receptacle's lower portion 350 in a shared manner. As such, there will be a transfer of forces to the receptacle base 320, which shall cause it to abut the projection 217, and may thereby cause the receptacle base 320 to break. This ensures that content stored within the bottle 300 flows out from the receptacle base 320, and flows towards an internal space of the lower portion of the inner case 210. The content will flow through the first connective channel 211 and the second connective channel 221 to flow out from the outer case 220 immediately thereafter. Finally, the content will then be sprayed out from the aerosol container under the entrainment of the propellant. With this, there is an increase in operational efficiency.

As shown in FIGS. 3 and 6, preferably, there is an annular area provided between the base of the projection 217 and the lower edges of the inner case side walls 214, with it being the area in which the lower edges of the side walls of the receptacle abuts thereto after the receptacle base 320 is broken.

Though the annular area provided between the base of the projection 217 and the lower edges of the inner case side walls 214, after the receptacle base 320 is broken, the lower edges of the side walls of the receptacle abut the annular area, thereby preventing further breakage of the receptacle through the lower edges of the side walls of the receptacle after the receptacle is broken. With this, the downward force exerted by the receptacle side walls is then borne by the inner case base walls 215. It is noted that it is possible as well to raise the angle between the side surfaces of the projection 217 and the horizontal plane while the height of the projection 217 remains the same. As such, this facilitates the concentration of an applied force, preferably in a downward direction, towards the upper ends of the side surface of the projection 217, thereby causing the receptacle base 320 of the receptacle 300 to break.

As shown in FIGS. 3 and 6, preferably, there is a third sealing ring between the piston shaft 230 and the protective casing that provides a hermetic connection between them. Alternatively, an interference fit between the piston shaft 230 and the protective casing provides a hermetic connection between them.

Through the third sealing ring or interference fit that provides a hermetic connection between the piston shaft 230 and the protective casing, the high-pressure propellant external to the protective casing is prevented from reaching the internals of the protective casing through spaces between the piston shaft 230 and the protective casing. Hence, the receptacle 300 is prevented from being subjected to the pressure force exerted by the propellant, which could have caused the receptacle 300 to break.

As shown in FIGS. 3 and 6, preferably, the third sealing ring (not shown) provides a hermetic connection between the piston shaft 230 and the inner case 210. Alternatively, an interference fit between the piston shaft 230 and the inner case 210 provides a hermetic connection between them.

In particular, in the embodiments that shall be described below, the height of the outer case 220 can be much shorter than the height of the inner case 210. For example, the height of the outer case 220 may be ⅓, ¼, or ⅕ the height of the inner case 210. This shall allow the immediate realization of a hermetic connection between the piston shaft 230 and the upper body portion of the inner case 210. Hence, this shall prevent the high-pressure propellant external to the inner case 210 from entering it through spaces between the piston shaft 230 and the inner case 210, which could have caused the receptacle 300 to break due to being subjected to high-pressure forces exerted by the propellant.

Evidently, in the embodiments that shall be described below, the protective casing of the protection assembly 200 protects the receptacle 300 from being broken. However, if the receptacle 300 breaks, perchance, while the inner case 210 is in the first position, as long as the inner case 210 remains in the first position, the protective casing may still prevent a mixing of fluids between (i) the fluid content that was stored in the receptacle 300 and (ii) the fluid in the place between the protection assembly 200 and the can body 100, by retaining the fluid content that was stored in the receptacle 300 within the protective casing until the inner case 210 is made to move to the second position. Hence, the protective casing may be made of durable and non-breakable material, and it may further be corrosion-resistant.

Evidently, in the embodiments that shall be described below, upon breaking of the receptacle 300, the remains of the broken receptacle 300 may be retained within the protective casing of the protection assembly 200 and shall not freely move about within the aerosol container.

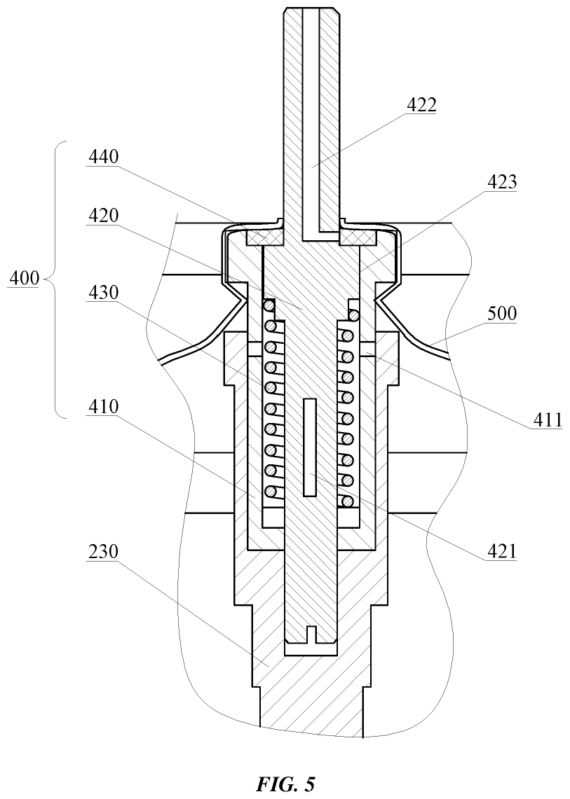

FIG. 5 is a schematic illustration of the control valve of the aerosol container as per FIGS. 1 to 3. As shown in FIG. 5, preferably, the aerosol container further comprises a control valve 400. The control valve 400 is positioned within the can body 100, and provides a hermetic connection between the can body 100 and its components, which include a valve housing 410, a valve stem 420 within the valve housing 410, and a resilient member 430 for moving the valve stem 420 and for causing the valve housing 410 and the valve stem 420 to be in contact in a hermetic manner. The top end of the valve stem 420 axially passes through the top portion of the valve housing 410 in a hermetic manner, while the bottom end of the valve stem 420 axially passes through the bottom portion of the valve housing 410. When the valve stem 420 receives an applied force, the valve stem 420 acts upon the protective casing, whereby it shall move, preferably by means of pushing, the piston shaft 230 towards the receptacle 300, having content therein, for the piston shaft 230 to exert the applied force onto the receptacle 300 to break it from its sealed state.

In particular, the aerosol container comprises a can body 100 and a mounting cup 500 is fitted onto the can body 100 in a hermetic manner. Whereas, the control valve 400 is positioned at the top portion of the can body 100 and is connected to it in a hermetic manner through the mounting cup 500. More specifically, the valve housing 410 is positioned at the upper portion of the can body 100, and an inner gasket 440 provides a hermetic connection between it and the mounting cup 500. Moreover, the valve stem 420 and valve housing 410 are configured to slide relative to each other. When the valve housing 410 is in an initial state, the location in which the valve stem 420 passes through the top portion of the valve housing 410 is connected to the valve housing 410 in a hermetic manner, while the location in which the valve stem 420 passes through the bottom portion of the valve housing 410 is connected to the valve housing 410 in a hermetic manner. The resilient member 430 is installed onto the valve stem 420, with one of its ends abutting the inner walls of the base of the valve housing 410, and with the other end abutting locations along the valve stem body 423, with it providing an upward elastic force to the valve stem 420. This is so that when the valve stem 420 does not receive an externally applied force, the resilient member 430 does not experience compression, and continuously pushes the valve stem body 423 of the valve stem 420 to abut against the inner gasket 440. It is noted that the resilient member may be a cylindrical helical compression spring.

The upper portion of the piston shaft 230 is to be configured to move relative to the valve housing 410 as well, with it being installed about the circumferential centre of the valve housing 410 and the lower side portion of the valve housing 410. Moreover, there is a counterbore present at the circumferential centre of the top end of the piston shaft 230. When the valve stem 420 receives an applied force and is made to extend from the base of the valve housing 410 by a distance that is large enough, the valve stem 420 may penetrate the said counterbore and transfer the applied force to the base of the counterbore. This will cause a movement in the piston shaft 230, which shall also cause a movement in the inner case 210 for eventually causing the receptacle 300 to break.

By having the valve stem 420 configured as such, it can cause a movement in the pistons shaft 230, thereby converting an applied force originating from the outside of the aerosol container into a movement in the piston shaft 230, so as to break the receptacle 300, thereby increasing operational convenience of the aerosol container. Moreover, when there is no applied force originating from the outside of the aerosol container, the valve stem 420 remains in contact with the valve housing 410 in a hermetic manner under the influence of the resilient member 430, thereby preventing propellant from leaking out from the can body 100.

As shown in FIG. 5, preferably, the side walls of the valve housing 410 are configured to have a third connective channel 411. This third connective channel 411 is to provide a connectivity between a first space and a second space. The first space is defined to be a space between the valve housing 410 and the valve stem 420, while the second space is defined to be a space that is the internals of the can body 100. The inner-side surfaces of the top portion of the piston shaft 230 are to be connected to the valve housing 410 in a hermetic manner. The top portion of the piston shaft 230 is to be used for blocking or unblocking the third connective channel 411.

In particular, there is a hermetic connection between the inner side surfaces of the top portion of the piston shaft 230 and the valve housing 410. When the valve stem 420 is moved downwardly to be at a position above the third connective channel 411 while not causing a movement in the piston shaft 230, the propellant may be prevented from flowing through the third connective channel. Moreover, after the valve stem 420 pushes piston shaft 230 for breaking the receptacle 300, the aforementioned hermetic connection will now be positioned below the third connective channel 411, which shall not disturb the propellant and content flowing within the third connective channel 411.

Through the provision of a third connective channel 411, the propellant may enter the valve housing 410 through the sidewalls of the valve housing 410. Moreover, when the valve stem 420 is at a closed position while not causing a movement in the piston shaft 230, the piston shaft 230 may block off the third connective channel 411. With the piston shaft 230 blocking off the propellant from entering the third connective channel 411, the leakage of propellant from the aerosol container is prevented, thereby providing the aerosol container with an enhanced leakage prevention. Moreover, when the aerosol container is to be used in an inverted manner after the receptacle 300 is broken, the content, having been released from the receptacle 300 and entrained with the propellant external to the outer case 220, may enter the valve housing 410 through the third connective channel 411 to be eventually sprayed out from the aerosol container.

As shown in FIG. 5, preferably, there is a hermetic connection between the lower portion of the valve stem 420 and a through-hole at the base of the valve housing 410. The centre portion of the valve stem 420 has a guide channel 421. When the lower portion of the valve stem 420 passes through and protrudes out from the valve housing 410 at a maximum value, the guide channel 421 establishes a connectivity between a first space and a second space. The first space is defined as a space between the valve housing 410 and the valve stem 420, while the second space is defined as a space between valve housing 410 and the internals of the can body 100. When the valve stem 420 is not depressed, the entirety of the guide channel 421 is to be within the valve housing 410.

In particular, the location of a hermetic connection between the lower portion of the valve stem 420 and the through-hole at the base of the valve housing 410 is located below the aforementioned guide channel 421. When the valve stem 420 is not depressed, the hermetic connection between the lower portion of the valve stem 420 and the through-hole at the base of the valve housing 410 remains unchanged, and the entirety of the guide channel 421 remains within the valve housing 410. Hence, no connectivity is established between the inside and outside of the valve housing 410 at its base.

With the guide channel 421 being at the base of the valve stem 420, and with a hermetic connection between the lower portion of the valve stem 420 and the through-hole at the base of the valve housing 410, when the valve stem 420 is not depressed, it is possible for the valve stem 420 block off the connectivity between the inside and outside of the valve housing 410 at the base of the valve housing 410. Whereas, when the valve stem 420 is depressed, it is possible for the valve stem 420 to establish the connectivity between the inside and outside of the valve housing 410 at the base of the valve housing 410. Hence, this will result in an increased velocity in spray flow as there is now an increased channel area for gas within the can body 100 to flow out through the valve housing 410.

As shown in FIG. 5, preferably, the guide channel 421 further comprises a flow-guiding groove that is parallel to the radial direction of the valve stem 420 or along the radial direction of the valve stem 420. The flow-guiding groove is at least recessed at the peripheral surface of the lower portion of the valve stem 420 and extends along the axial direction of the valve stem 420, When the lower portion of the valve stem 420 passes through and protrudes out from the valve housing 410 at a maximum value, portions of the flow-guiding groove are located within the valve housing 410, and its remaining portions located outside of the valve housing 410.

In particular, the guide channel 421 may be formed by the flow-guiding groove that is machined onto the middle portion of the valve stem 420, with the flow-guiding groove machined in a direction that is parallel to the radial direction of the valve stem 420 or along the radial direction of the valve stem 420. The flow-guiding groove that forms the guide channel 421 may be in the form of a counterbore groove, which may or may not extend transversely through the middle portion of the valve stem 420. In an alternative embodiment, the flow-guiding groove that forms the guide channel 421 may be in the form of a trench groove that is dug at the sides of the middle portion of the valve stem 420, as long as the cross-sectional shape of through-holes (e.g., circular shape) that may be along valve stem 420 is compromised. In a further alternative embodiment, the flow-guiding groove that forms the guide channel 421 may be in the form of blind holes whereby two parallel blind holes are drilled onto the middle portion of the valve stem 420 along its radial direction, with a third blind hole drilled at the base of the valve stem 420 for connecting both of the aforementioned blind holes. The outer end of the third blind hole will then be plugged.

As shown in FIG. 5, the top portion of the valve stem 420 has a discharge channel 422, which further comprises an outlet on the tip of the valve stem 420 and an inlet at the upper side portions of the valve stem 420.

In particular, when the valve stem 420 is not depressed, the inlet is to be located at the through-hole at the top portion of the valve housing 410. The location of a hermetic connection between the valve stem 420 and the inner gasket 440, for example, the location where the top portion of the aforementioned valve stem body 423 abuts the inner gasket 440, is to be located below the inlet. When the valve stem 420 is depressed, the inlet of the discharge channel 422 will now be located below the through-hole at the top portion of the valve housing 410, and the inlet shall not be restricted by the sealed connection between the valve stem 420 and the top portion of the valve housing 410. Hence, when the valve stem 420 is depressed, a mixture of propellant and content in the space within the valve housing 410 will be discharged out through the discharge channel 422, and will be sprayed out from the aerosol container through a spray nozzle which is to be described below.

Not only that, the aerosol container further comprises a spray nozzle (not shown), which is to be installed over the top portion of the valve stem 420 and above the mounting cup 500. The spray nozzle may be referred to as a press-type spray nozzle or a cap-type spray nozzle, and is to be primarily used for actuating the valve stem 420 for spraying content out from the container. Since this component is to be a conventional product within the art, it shall not be described further.

Furthermore, besides the control valve 400 as shown in FIG. 5, the control valve 400 may be of the embodiment that has been previously disclosed in the Chinese Patent CN113631488A. The description of such an embodiment shall not be repeated herein.

As shown in FIGS. 1, 2, 3, and 6, preferably, the aerosol container further comprises mixing members 600 in the form of mixing balls, which are disposed between the protective casing and the can body 100.

Normally, when the aerosol container is stored or transported, it is in an upright manner with its top portion oriented upwards. The mixing members 600 will then be located at the bottom of the space between the protective casing and the can body 100. Hence, in the third and fourth embodiments to be described below, even though the outer case 220 is configured to only cover the bottom portion of the inner case 210, the protective function of the protective casing will still be provided.

In order to provide a clearer presentation of the implementation of the present application, its three embodiments shall now be described in detail. These three embodiments differ mainly in the manner in which the inner case 210 and the outer case 220 are arranged, and the manner in which the receptacle 300 is made broken by the components of the aerosol container. Hence, only these aspects shall be described for each of the following embodiments. The remaining descriptions that may pertain to the structure and principles of these embodiments are regarded to have been completely described above, and thus, shall not be repeated.

### First Embodiment

As shown in FIG. 1, in this embodiment, the top portion of the outer case 220 is located at the lower portion of the inner case 210, with the inner case 210 having the inner case body. The pressure-application section 231 of the piston shaft 230 is to abut the top surface of the inner case 210. But prior to the use of the aerosol container, the pressure-application section 231 of the piston shaft 230 may or may not abut the top surface of the inner case 210. Whereas, the receptacle 300 is positionally orientated in an inverted manner, with its receptacle tip 310 abutting the inner walls of the inner case base walls 215. The circumferential surface of the flange portion 232 of the piston shaft 230 has a second sealing ring 233 disposed thereupon, which provides a hermetic connection between the flange portion 232 and the top portion of the inner case 210. Regardless of the relative movement between the piston shaft 230 and the inner case 210, the hermetic connection between the flange portion 232 and the top portion of the inner case 210 remains.

Moreover, a first sealing ring 212 provides a hermetic connection between the base of the inner case side walls 214 and the outer case 220. Prior to the use of the aerosol container, the first sealing ring 212, the first connective channel 211, the first sealing ring 212, and the second sealing ring 233 are arranged in a sequential manner from top to bottom. The first sealing ring 212, which is positioned below the first connective channel 211, blocks off a connectivity between the first connective channel 211 and the second connective channel 221. The first sealing ring 212, which is positioned above the first connective channel 211, blocks off a connectivity between the first connective channel 211 and the top portion of the outer case 220.

### The Principle of Operation of the First Embodiment is as Follows

Prior to the use of the aerosol container, the valve stem 420 is pushed upwards by the resilient member 430, for an end of the valve stem body 423 of the valve stem 420 to be in a hermetic connection with the inner gasket 440. Hence, there will be no connectivity between the internals of the valve housing 410 and the upper portion of the valve housing 410, and as such, there will be no connectivity to the discharge channel 422. The entirety of the guide channel 421 located in the middle portion of the valve stem 420 remains within the valve housing 410, and will not establish a connectivity between the inside and the outside of the valve housing 410. The top portion of the piston shaft 230 blocks the third connective channel 411 that is located at the side walls of the valve housing 410. As such, the propellant within the can body 100 will not be allowed to enter the internals of the valve housing through the third connective channel 411.

As the inner case 210 is located at the aforementioned first position, the first connective channel 211, the first sealing ring 212, and the second sealing ring 233 are arranged sequentially from top to bottom. The first sealing ring 212 blocks off a connectivity between the first connective channel 211 and the second connective channel 221. Moreover, there is a hermetic connection between the top portion of the inner case 210 and the flange portion 232 of the piston shaft 230. With this, the receptacle 300 will not be subjected to the pressure force exerted by the propellant, which could have broken the receptacle 300.

When the valve stem 420 starts being depressed by an applied force, the valve stem 420 moves the base of the counterbore located on the top portion of the piston shaft 230, thereby causing a downward movement in the piston shaft 230. With this, first, the pressure-application section 231 of the piston shaft 230 transfers the applied force to the receptacle base 320 of the receptacle 300. Then, the receptacle tip 310 of the receptacle 300 moves the inner case base walls 215 of the inner case 210. Then, the inner case 210 will move relative to the outer case 220, preferably in a downwards manner, for the inner case 210 to reach the aforementioned second position. This causes the first sealing ring 212 to move downwards and move past the second connective channel 221, thereby allowing a connectivity to be established between the first connective channel 211 and the second connective channel 221. It is most preferable that both of these channels 211, 221 are aligned to each other.

After the inner case 210 fully moves to its proper position, should the applied force be continuously applied in a gradually increasing manner, the piston shaft 230 will continuously exert this applied force onto the receptacle 300. When the receptacle 300 is finally unable to withstand this applied force, the receptacle base 320 of the receptacle 300 will be broken by the pressure-application section 231, and as such, the content stored within the receptacle 300 is released therefrom into the inner case 210. Then, the content within the inner case 210 will flow out from the outer case 220 through the first connective channel 211 and the second connective channel 221. With this, the content is then mixed with the propellant with the aid of the mixing members 600 for an improved mixing effect.

At this point, since the valve stem 420 has moved relative to the valve housing 410, preferably in a downward manner, the guide channel 421, which is located in the middle portion of the valve housing 410, has its upper end and lower end each now located above and below the base of the valve housing 410 respectively. This shall allow the guide channel 421 to establish a connectivity between the inside and the outside of the valve housing 410. However, since the base of the valve housing 410 is in a hermetic contact with the piston shaft 230, the propellant and the content will not enter the valve housing 410 through the guide channel 421. The third connective channel 411 located on the side walls of the valve housing 410 will not be covered by the piston shaft 230. Should the aerosol container be used in an inverted manner though, a mixture of propellant and content may enter the internals of the valve housing 410 through the guide channel 421. Hence, the mixture of propellant and content located between the valve housing 410 and can body 100 may still enter the valve housing 410. At this point as well, the inlet of the discharge channel 422 at the upper portion of the valve stem 420 will now be located within the valve housing 410, which will naturally allow the mixture to be sprayed out from the aerosol container by it flowing through the discharge channel 422 and the nozzle (not shown).

### Second Embodiment

As shown in FIG. 2, the differences between the first embodiment and this second embodiment are as follows:
(i) in the first embodiment, a first sealing ring 212 provides a hermetic connection between the inner case 210 and the outer case 220, whereas, in this second embodiment, an interference fit between the inner case 210 and the outer case 220 provides a hermetic connection between them; and
(ii) in the first embodiment, a second sealing ring 233 provides a hermetic connection between the circumferential surface of the flange portion 232 and the top portion of the inner case, whereas, in the second embodiment, an interference fit between the circumferential surface of the flange portion 232 and the top portion of the inner case 210 provides a hermetic connection between them.

The remaining descriptions that may pertain to the structure and principles of the second embodiment are similar to that of the first embodiment, and thus, shall not be repeated.

It should be noted that in alternative embodiments, the means that provide a hermetic connection between the inner case 210 and the outer case 220 may differ from the means that provide a hermetic connection between the circumferential surface of the flange portion 232 and the top portion of the inner case 210. For example, the first sealing ring 212 may provide a hermetic connection between the inner case 210 and the outer case 220, while an interference fit between the circumferential surface of the flange portion 232 and the top portion of the inner case 210 provides a hermetic connection between them. Other than that, an interference fit between the inner case 210 and the outer case 220 provides a hermetic connection between them, while a second sealing ring 233 may provide a hermetic connection between the circumferential surface of the flange portion 232 and the top portion of the inner case 210.

### Third Embodiment

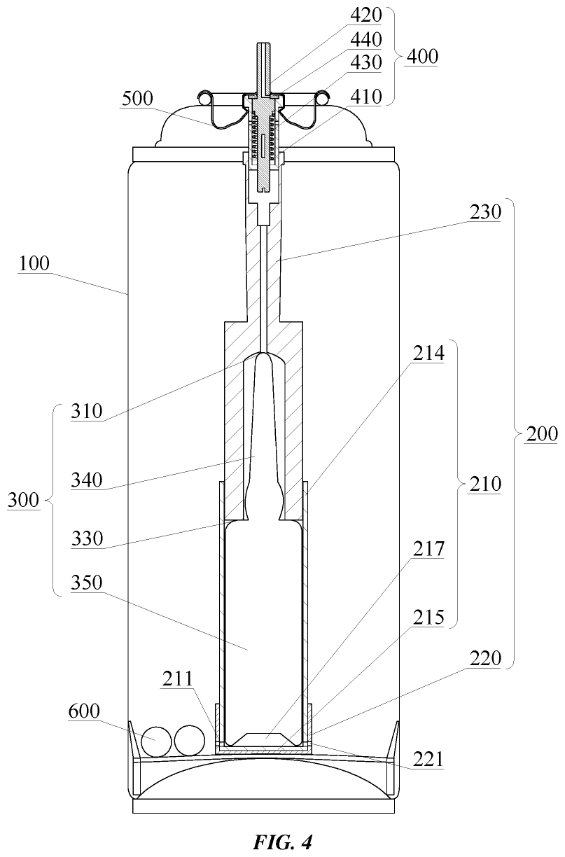

FIG. 4 is a schematic illustration of the aerosol container of the present invention in its third embodiment in a configuration whereby its piston shaft 230 had moved its inner case 210 to assume a certain position. As shown in FIGS. 3 and 4, in this embodiment, the outer case 220 does not fully cover the entire height of the inner case 210, for example, it may only cover the lower portion of the inner case 210 by ¼, ⅕, or ⅙ of the height of the inner case 210.

Moreover, the first connective channel 211 of the inner case 210 is configured to be at the base of the inner case 210. As such, the outer case 220 is only required to cover the lower portion of the inner case 210, thereby preventing a connectivity between the first connective channel 211 of the inner case 210 and the externals of the outer case 220. In particular, in this embodiment, at the above and the below of the first connective channel 211, the inner case 210 has an essentially hermetic connection with the outer case 220, the means by which may be done through, for example, an interference fit between them, for preventing a connectivity between the first connective channel 211 and the externals of the outer case 220. Hence, the outer case 220 may cover a local height of the lower portion of the inner case 210. The height of the outer case 220 plays a role in guiding the movements of the inner case 210, as well as indirectly guiding the movements of the piston shaft 230. As such, it is not necessary for the outer case 220 to have a height that covers the entire height of the inner case 210 or the receptacle 300.

The inner sides of the top portion of the inner case 210 and the outer sides of the piston shaft 230 may have a hermetic connection between them through a third sealing ring or an interference fit between them. This shall prevent pressure exerted by the propellant from the can body 100 from acting upon the receptacle 300.

In this embodiment, the receptacle 300 is configured to be oriented in an upright manner, with the receptacle tip 310 of the receptacle 300 facing upwards and the receptacle base 320 of the receptacle 300 facing downwards. The base of the piston shaft 230 may abut the receptacle shoulders 330 of the receptacle 300. Moreover, the inner side surfaces of the inner case base walls 215 are configured to have projection 217. When the receptacle 300 is subjected to an applied force, the receptacle base 320 of the receptacle 300 may break for content stored therein to be released. Moreover, at the inner case base walls 215, there is an annular area in between the projection 217 and the inner case side walls 214.

### The Principle of Operation of the Third Embodiment is as Follows

Components and operations related to the control valve 400 may be referenced from the descriptions of the first embodiment, and thus, shall not be repeated. The following shall only describe operations relating to the breaking of the receptacle 300, and the relative movements between the inner case 210 and the outer case 220.

As shown in FIG. 3, when the aerosol container is not in use, since the inner case is at its aforementioned first position, the first connective channel 211 and the second connective channel are blocked off from each other. Moreover, there is a hermetic connection between the top portion of the inner case 210 and the piston shaft 230. As such, the receptacle 300 will not be subjected to the pressure force exerted by the propellant, and the receptacle 300 shall not be broken by this pressure force.

When the valve stem 420 is depressed by an applied force, the valve stem 420 moves the base of the counterbore on the piston shaft 230, thereby causing a movement in the piston shaft 230, preferably in the downward direction. With this, first, the base of the piston shaft 230 abuts the bottle shoulder 330 of the receptacle 300, with the applied force being transferred across the bottle's lower portion 350, so that the receptacle base 320 is eventually held against the projection 217. As the piston shaft 230 continuously moves in a downwards manner, the receptacle 300 shall begin to move and abut the inner case 210, causing them to move together, preferably in a downwards manner. With this, the inner case 210 shall then reach the aforementioned second position, where a connectivity is established between the first connective channel 211 and the second connective channel 221. It is most preferable that both of these channels 211, 221 are aligned to each other.

After the inner case 210 has fully moved into position, the applied force is exerted onto the piston shaft 230 by the valve stem 420. The receptacle base 320 of the receptacle 300 may not withstand this increasing applied force and may be broken by the projection 217, thereby causing content stored within the receptacle 300 to be released into the inner case 210. With this, the content, now within the inner case 210 will flow out to the outside of the outer case 220 through the first connective channel 211 and the second connective channel 220. The content will then be then mixed with the propellant with the aid of the mixing members 600 for an improved mixing effect.

In this embodiment, since the lower portion of the piston shaft 230 has a through-hole that runs across it in a vertical direction, the ends of the through-hole provide a connectivity between a space external to the outer sides of the receptacle tip 310 of the receptacle 300 and a counterbore at the circumferential centre of the top surface portion of the piston shaft 230. Hence, after the receptacle 300 is broken, the content, under the entrainment of the propellant, may move upwards through this through-hole to reach a space within the counterbore at the circumferential centre of the top surface portion of the pistons shaft 230. Then, it will flow through the guide channel 421 to enter the valve housing 410, and eventually, be sprayed out from the aerosol container by it flowing through the discharge channel 422 and the nozzle (not shown).

### Fourth Embodiment

FIG. 6 is a schematic illustration of the aerosol container in a fourth embodiment, which is similar to the aerosol container in the third embodiment as shown in FIGS. 3 and 4 but with some differences in its construction and operation.

The difference between the third embodiment and this fourth embodiment is as follows:
(i) in the third embodiment, its piston shaft 230 and its valve stem 420 are configured to move axially with respect to each other when an applied force is applied onto the valve stem 420 so that the applied force is transferred and exerted onto the receptacle 300 for it to eventually break. Whereas, in this fourth embodiment, its piston shaft 230 and its valve stem 420 are configured to move axially and radially with respect to each other. More specifically, in this fourth embodiment its piston shaft 230 and its valve stem 420 are in a threaded engagement with each other. When an applied force is exerted onto the valve stem 420 in the form of torque, this applied force is transferred and exerted onto the receptacle 300 by the piston shaft 230, for the receptacle 300 to eventually break. The rotational motion of the applied force in the form of torque may be in a clockwise or anti-clockwise direction depending on threads on the piston shaft 230 and its valve stem 420.

The remaining descriptions that may pertain to the structure and principles of this fourth embodiment are similar to that of the third embodiment, and thus, shall not be repeated. The structure and principles of this fourth embodiment may similarly be further extended to the first embodiment and the second embodiment.

It should be noted that besides this fourth embodiment as shown, there may be further alternative embodiments with alternative configurations that allow the piston shaft 230 to provide a force that breaks the receptacle 300.

In certain alternative embodiments, the piston shaft 230 may interact with other components within the aerosol container other than the valve stem 420 for it to provide a force that breaks the receptacle 300, which may be, by way of example, include other components of the control valve, the protection assembly 200 (if so configured), mounting cup 500 (if so configured), or the mixing members 600 (is so configured).

In certain alternative embodiments, the force applied by the piston shaft 230 onto the receptacle 300 for breaking it may originate from any other direction besides as described. For example, the piston shaft 230 may apply or exert a force in an upwards direction, sideways direction, or diagonal direction for breaking the receptacle 300. The piston shaft 230 may also be configured to receive and exert forces in one or more directions for breaking the receptacle 300. However, it is preferred that it is still ensured that connective channels 211, 221 of the protective casing become connected during or after breaking the receptacle 300, so that contents of the receptacle 300 are released therefrom to a space external to the protective casing.

### The Principle of Operation of the Fourth Embodiment is as Follows

Components and operations related to the protective casing of the protection assembly 200 and certain components of the control valve 400 may be referenced from the descriptions of the third embodiment, and thus, shall not be repeated. The following shall only describe operations relating to the breaking of the receptacle 300 due to relative movements between the valve stem 420 of the control valve 400 and the piston shaft of the protection assembly 200.

As shown in FIG. 6, when the aerosol container is not in use, threaded portions of the valve stem 420 are to be substantially within a threaded counterbore of the piston shaft 230 that is located at the top portion of the piston shaft 230. Preferably, the threads of the valve stem 420, or portions thereof, are in engagement with the threads of the piston shaft 230.

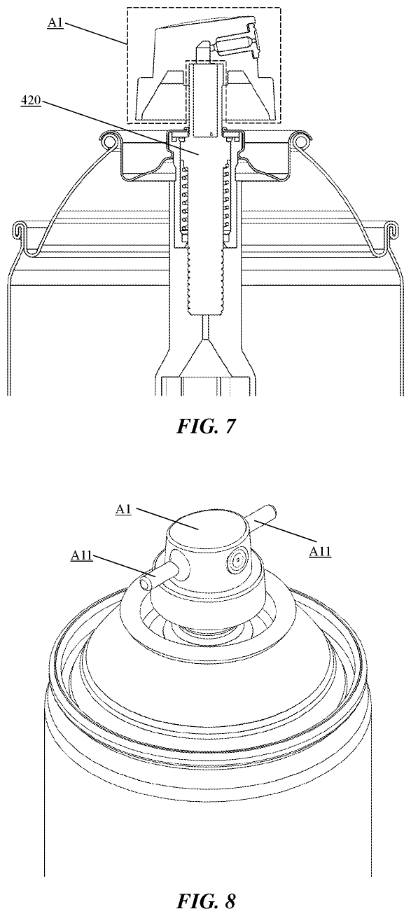

As shown in FIG. 7 and FIG. 8, this fourth embodiment may further include a corresponding nozzle A1 that may be fitted over its control valve 400 that is configured to facilitate the provision of an applied force to the valve stem 420. More specifically, as shown in FIG. 8, the corresponding nozzle A1 may further be integrated with one or more rods A11 that act as levers that receive an applied force in the form of torque through a rotational motion.

As this fourth embodiment undergoes use, the rods A11 on the nozzle A are rotated to rotate the valve stem 420. With this, the valve stem 420 moves axially and radially according to the threads of the counterbore of the piston shaft 230, preferably in a downward direction. The valve stem 420 is to travel along said counterbore until it reaches the base of the counterbore. Preferably, upon a continued application of torque onto the valve stem 420, the torque is transferred to the piston shaft 230 as an applied force that is exerted onto the base of the said counterbore. With this, the piston shaft 230 exerts the applied force onto the receptacle 300 so that the receptacle 300 breaks and releases its contents. While doing so, the conductive channels 211, 221 of the protective casing may become connected for the content to reach the space external to the protective casing.

### Fifth Embodiment

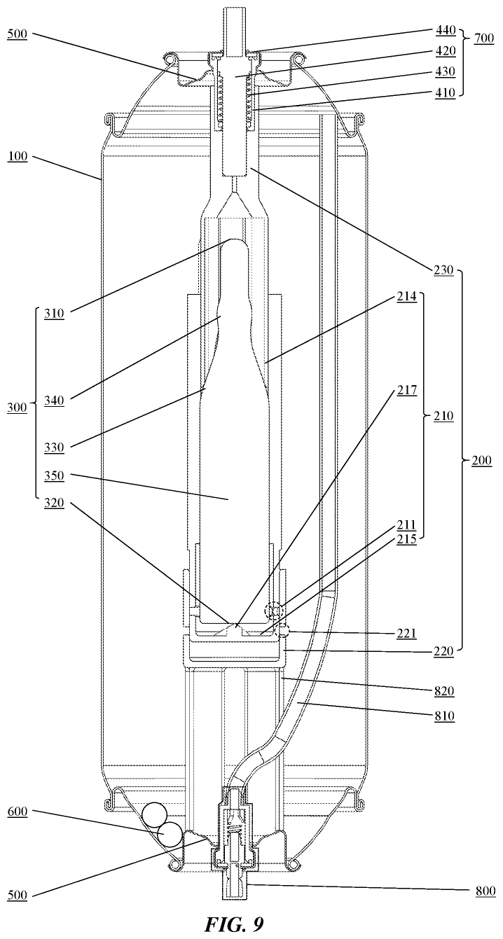

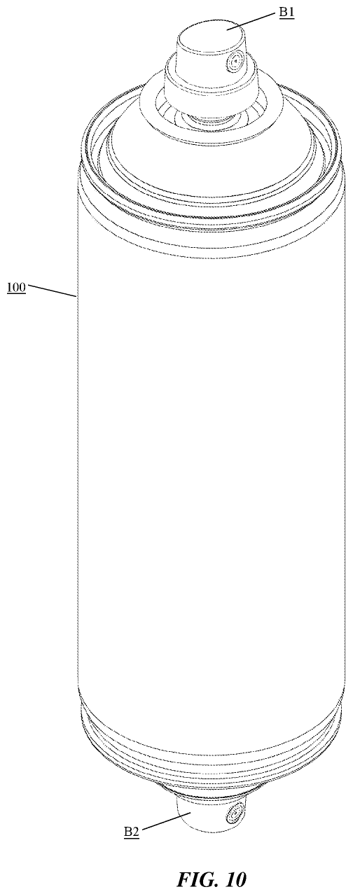

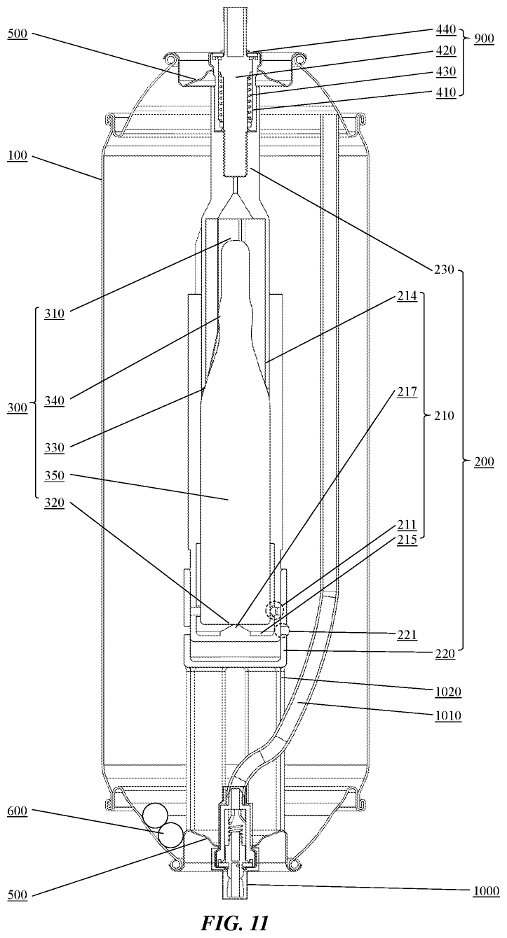

FIG. 9 is a schematic illustration of the aerosol container in a fifth embodiment, and FIG. 10 is an illustration of an external perspective view of the aerosol container of the fifth embodiment, with its corresponding nozzles B1, B2. This fifth embodiment is a derivative of the aerosol container of the third embodiment as shown in FIGS. 3 and 4. More specifically, this fifth embodiment has at least two control valves to provide a multi-spray configuration. Preferably, this fifth embodiment has a first control valve 700 which is similar to the control valve 400 of the third embodiment that may be fitted with a corresponding nozzle B1, and a second control valve 800 which is an additional control valve that may be with a corresponding nozzle B2 that serves to spray content out from the aerosol container under the entrainment of the propellant.

Preferably, the descriptions that may pertain to the structure and principles of the first control valve 700 are similar to that of control valve 400 of the third embodiment, and thus, shall not be repeated. Alternatively, the first control valve 700 may be of the embodiment that has been previously disclosed in the Chinese Patent CN113631488A, and the description of such an embodiment shall not be repeated herein

Preferably, the second control valve 800 may substantially be similar to a conventional control valve connected to a dip tube 810, for spraying content from the aerosol container to the external environment under the entrainment of the propellant. Alternatively, the second control valve 800 may substantially be similar to the embodiment that has been previously disclosed in the Chinese Patent CN113631488A, and the description of such an embodiment shall not be repeated herein.

In particular, in this fifth embodiment, the first control valve 700 and the second control valve 800 are preferably positioned along the aerosol container to be aligned with each other, with the protection assembly 200, having the receptacle 300 therein, disposed in-between them. Preferably, the components of the first control valve 700 interact with protection assembly 200 for breaking the receptacle 300 therein. Preferably, the second control valve 800 supports the protection assembly 200 by providing a support structure 820 for the protective casing of the protection assembly 200 to rest against. With this, the protection assembly 200 may remain substantially upright between the first control valve 700 and the second control valve 800.

The remaining descriptions that may pertain to the structure and principles of this fifth embodiment are similar to that of the third embodiment, especially regarding the protection assembly 200 and the receptacle 300, and thus, shall not be repeated. The structure and principles of this fifth embodiment may similarly be further extended to the protection assembly 200 and the receptacle 300 of the first embodiment and the second embodiment.

### The Principle of Operation of the Fifth Embodiment is as Follows

Components and operations related to the protective casing of the protection assembly 200 and certain components of the first control valve 700 may be referenced from the descriptions of the third embodiment as shown in FIGS. 3 and 4, and thus, shall not be repeated. Operations relating to the breaking of the receptacle 300 due to relative movements between the valve stem 420 of the first control valve 700 and the piston shaft of the protection assembly 200 may be referenced from the descriptions of the third embodiment as shown in FIGS. 3 and 4, and thus, shall not be repeated.

### Sixth Embodiment

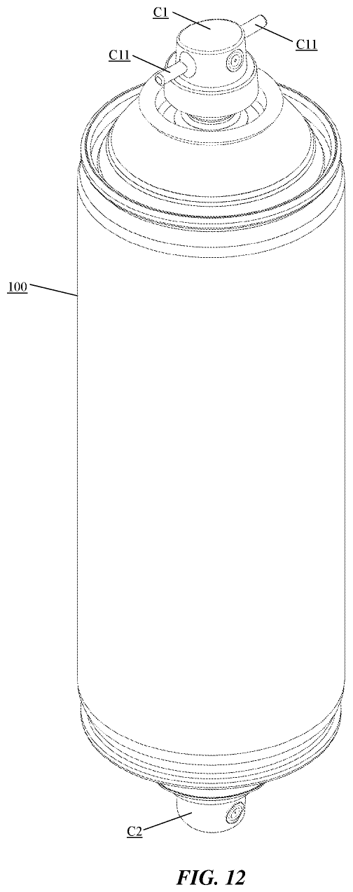

FIG. 11 is a schematic illustration of the aerosol container in a sixth embodiment, and FIG. 12 is an illustration of an external perspective view of the aerosol container of the sixth embodiment, with its corresponding nozzles C1, C2. This sixth embodiment is derivative of the aerosol container of the fourth embodiment as shown in FIGS. 6 to 8. More specifically, this sixth embodiment has at least two control valves to provide a multi-spray configuration. Preferably, this sixth embodiment has a first control valve 900 which is similar to the control valve 400 of the third embodiment that may be fitted with a corresponding nozzle C1 having one or more rods C11 that act as levers, and a second control valve 1000 which is an additional control valve that may be fitted with a corresponding nozzle C2 that serves to spray content out from the aerosol container under the entrainment of the propellant.

Preferably, for this sixth embodiment, the descriptions that may pertain to the structure and principles of its first control valve 900 are similar to that of control valve 400 of the fourth embodiment, and thus, shall not be repeated. Alternatively, its first control valve 900 may be of the embodiment that has been previously disclosed in the Chinese Patent CN113631488A, and the description of such an embodiment shall not be repeated herein

Preferably, for this sixth embodiment, its second control valve 1000 may substantially be similar to a conventional control valve connected to a dip tube 1010, for spraying content from the aerosol container to the external environment under the entrainment of the propellant. Alternatively, the second control valve 1000 may substantially be similar to the embodiment that has been previously disclosed in the Chinese Patent CN113631488A, and the description of such an embodiment shall not be repeated herein.

In particular, in this sixth embodiment, its first control valve 900 and its second control valve 1000 are preferably positioned along the aerosol container to be aligned with each other, with the protection assembly 200, having the receptacle 300 therein, disposed in-between them. Preferably, the components of its first control valve 900 interact with its protection assembly 200 for breaking the receptacle 300 therein. Preferably, the second control valve 1000 supports the protection assembly 200 by providing a support structure 1020 for the protective casing of the protection assembly 200 to rest against. With this, the protection assembly 200 may remain substantially upright between the first control valve 900 and the second control valve 1000.

The remaining descriptions that may pertain to the structure and principles of this sixth embodiment are similar to that of the fourth embodiment, especially regarding the protection assembly 200 and the receptacle 300, and thus, shall not be repeated. The structure and principles of this sixth embodiment may similarly be further extended to the protection assembly 200 and the receptacle 300 of the first embodiment and the second embodiment.

### The Principle of Operation of the Sixth Embodiment is as Follows

Components and operations related to the protective casing of the protection assembly 200 and certain components of the first control valve 900 may be referenced from the descriptions of the fourth embodiment as shown in FIGS. 6 to 8, and thus, shall not be repeated. Operations relating to the breaking of the receptacle 300 due to relative movements between the valve stem 420 of the first control valve 900 and the piston shaft of the protection assembly 200 may be referenced from the descriptions of the fourth embodiment as shown in FIGS. 6 to 8, and thus, shall not be repeated.

It is to be noted that, unless stated otherwise, the technical or scientific terms used herein are to be taken as terms that are commonly understood by those persons having ordinary skill in the art to which this invention belongs.

Within the description of the present application, it shall be understood that terms that indicate an orientation or positional relationship based on the drawings such as “length”, “width”, “thickness”, or the like, are intended for providing a convenient and simplified description of the invention. These terms are not intended to indicate or imply that devices or elements as described are required to have a particular orientation, or to be constructed and operated in a particular orientation. As such, these terms may not be construed as limiting to the present invention.

Furthermore, it will be understood that, the terms “first”, “second”, etc. used in the description are for descriptive purposes. These terms are not intended to be interpreted as an indication or implication of a relative importance in the features, or as an implicit indication of the number of features.

Furthermore, it will be understood that, spatially relative terms, such as “upper”, “lower”, “top”, “bottom”, “downwards”, “upwards”, and the like, may be used herein for ease of description to describe one element or feature's relationship to another element or feature as illustrated in the figures. It will be understood that the spatially relative terms are intended to encompass different orientations of the aerosol container in use or operation in addition to the orientation depicted in the figures. For example, if the aerosol container in the figures is turned over, elements described as “upper” other elements or features would then be oriented “lower” the other elements or features. Thus, the exemplary term “upper” can encompass both an orientation of above and below. The aerosol container may be otherwise oriented and the spatially relative descriptors used herein are interpreted accordingly.

Finally, it should be noted that the descriptions of the above embodiments are to illustrate the technical solutions provided by the present invention in a non-limiting manner. Although the present invention has been described in detail with reference to the foregoing embodiments, it will be understood by those skilled in the art that the technical solutions as described in these foregoing embodiments may be modified or substituted with equivalents for some or all of the technical features thereof. Such modifications or substitutions will not cause a substantial departure from the scope of the embodiments of the present invention, and are intended to be included in the claims and the description of the present invention. Numerous changes in the details of construction and the combination and arrangements of features in the various embodiments may be resorted thereto as long there are no structural conflicts. As a final note, the present invention shall not be limited to any particular disclosed embodiments, will include all technical solutions that fall within the scope of the claims.

1. An aerosol container comprising
a can body;
a receptacle; and
a protection assembly;
wherein
the receptacle is located within the can body for storing content;
the protection assembly is located within the can body and external to the receptacle for isolating the receptacle from a space external to the protection assembly prior to use of the aerosol container; and
the protection assembly includes an inner case having a first connective channel, and an outer case having a second connective channel, with the inner case and the outer case being arranged to move relative to each other.

2. The aerosol container according to claim 1, wherein the protection assembly further comprises a protective casing, and a piston shaft in connection with the protective case that is configured to apply pressure to the receptacle for breaking it so that its content is released therefrom.

3. The aerosol container according to claim 2, wherein the inner case and the outer case form the protective casing, with
the outer case covering at least an outer lower portion of the inner case; and
the inner case covering at least an outer lower portion of the receptacle.

4. The aerosol container according to claim 3, wherein
the first connective channel is at a lower portion of the inner case; and
the second connective channel is at a lower portion of the outer case.

5. The aerosol container according to claim 4, wherein the inner case is movable from a first position to a second position.

6. The aerosol container according to claim 5, wherein
the first connective channel and the second connective channel are blocked off from each other when the inner case is at the first position; and
the first connective channel and the second connective channel are connected to each other when the inner case is at the second position.

7. The aerosol container according to claim 6, wherein the first connective channel and the second connective channel, when the inner case is at the first position, are blocked off at locations being
between the first connective channel and the second connective channel; and
between the first connective channel and the top portion of the outer case.

8. The aerosol container according to claim 7, wherein the inner case is connected to the outer case through a first sealing ring in a hermetic manner; or
the inner case is connected to the outer case through an interference fit between them in a hermetic manner.

9. The aerosol container according to claim 2, wherein the piston shaft comprises a pressure-application section that applies pressure to the receptacle.

10. The aerosol container according to claim 9, wherein the receptacle
has its receptacle tip abutting base walls of the inner case; and
has an outer portion of its base being abutted by the pressure-application section of the piston shaft which applies pressure thereto.

11. The aerosol container according to claim 2, wherein
the piston shaft is connected to the protective casing through a second sealing ring in a hermetic manner; or
the piston shaft is connected to the protective casing through an interference fit between them in a hermetic manner.

12. The aerosol container according to claim 11, wherein the piston shaft has a flange portion, with a peripheral surface of the flange portion being connected to the protective casing through the second sealing ring in a hermetic manner; or connected to the protective casing through an interference fit between them in a hermetic manner.

13. The aerosol container according to claim 2, whereby
a base of the receptacle is abutted by a projection of the inner case that formed on an inner surface portion of base walls of the inner case; and
shoulders of the receptacle are abutted by a bottom portion of the piston shaft.

14. The aerosol container according to claim 13, wherein the projection of the protective casing and lower edges of the inner case have an annular area therebetween, for abutting lower edges of the receptacle after the receptacle base is broken.

15. The aerosol container according to claim 2, wherein
the piston shaft is connected to the protective casing through a third sealing ring in a hermetic manner; or
the piston shaft is connected to the protective casing through an interference fit between them in a hermetic manner.

16. The aerosol container according to claim 15, wherein
the piston shaft is connected to the inner case through the third sealing ring in a hermetic manner; or
the piston shaft is connected to the inner case through an interference fit between them in a hermetic manner.

17. The aerosol container according to claim 2, further comprising a control valve, which comprises
a valve housing disposed within the can body in a hermetic manner;
a valve stem, which is disposed within the valve housing; and
a resilient member, for pushing the valve stem so that the valve stem and valve housing remain connected in a hermetic manner.

18. The aerosol container according to claim 17, whereby
a tip of the valve stem is passed through an upper portion of the valve housing along the axial direction; and
a bottom end of the valve stem is passed through a lower portion of the valve housing along an axial direction, such that when the valve stem moves towards the protective casing, the valve stem pushes the piston shaft for the piston shaft to break the receptacle so that the content is released therefrom.

19. The aerosol container according to claim 17, further comprising additional control valves.

20. The aerosol container according to claim 1, wherein the receptacle is breakable and corrosion-resistant.

21. The aerosol container according to claim 1, further comprising mixing members disposed between the protection assembly and the can body.
